(19) United States
(12) Patent Application Publication
(10) Pub. No.: US 2007/0248886 A1
(43) Pub. Date: Oct. 25, 2007

(54) Non-aqueous electrolyte secondary battery

(76) Inventors: Hironori Shirakata, Osaka (JP); Hideki Kitao, Sakaiminato-city (JP); Yoshinori Kida, Osaka (JP)

Correspondence Address: KUBOVCIK & KUBOVCIK, SUITE 710, 900 17TH STREET NW, WASHINGTON, DC, 20006, US

(21) Appl. No.: 11/731,027

(22) Filed: Mar. 30, 2007

(30) Foreign Application Priority Data
Mar. 30, 2006 (JP) 2006-092675

(51) Int. Cl. H01M 4/58

(52) U.S. Cl. 429/231.95; 429/221; 429/224; 429/223

(57) ABSTRACT

A non-aqueous electrolyte secondary battery includes a positive electrode (11), a negative electrode (12), and a non-aqueous electrolyte (14). The positive electrode contains a lithium-free metal oxide and a positive electrode active material composed of an olivine-type lithium-containing phosphate represented by the general formula LiₓMPO₄, where M is at least one element selected from the group consisting of Co, Ni, Mn, and Fe, and 0<x<1.3.

### BACKGROUND OF THE INVENTION

1. Field of the Invention

The present invention relates to non-aqueous electrolyte secondary batteries. More particularly, the invention relates to a non-aqueous electrolyte secondary battery that has a positive electrode using an olivine-type lithium-containing phosphate as the positive electrode active material, in which its charge-discharge performance at large current is improved and thermal stability under high temperature conditions is enhanced.

2. Description of Related Art

In recent years, non-aqueous electrolyte secondary batteries have been used as new types of high power, high energy density secondary batteries. A non-aqueous electrolyte secondary battery typically uses a non-aqueous electrolyte and performs charge-discharge operations by transferring lithium ions between the positive and negative electrodes.

In the non-aqueous electrolyte secondary batteries, LiCoO₂ is commonly used as the positive electrode active material in the positive electrode.

The use of LiCoO₂, however, leads to high manufacturing costs because cobalt is an exhaustible and scarce natural resource. Moreover, a non-aqueous electrolyte secondary battery that uses LiCoO₂ as the positive electrode active material suffers significant degradation in thermal stability when the battery in a charged state is placed in a high temperature environment.

In view of these problems, research has been conducted in recent years on the use of olivine-type lithium-containing phosphates, such as lithium iron phosphate LiFePO₄, as an alternative to LiCoO₂ as a positive electrode active material.

The olivine-type lithium-containing phosphate is a lithium composite compound represented by the general formula LiMPO₄ (where M is at least one element selected from the group consisting of Co, Ni, Mn, and Fe), which offers many advantages as follows. When Fe, Ni, Mn, or the like is used as the metal element M thereof, a low-cost positive electrode active material is obtained. Moreover, olivine-type lithium-containing phosphate shows various working voltages depending on the type of the metal element M, so it is possible to select the battery voltage freely set by the choice of the main metal element M. The battery using the olivine-type lithium-containing phosphate material also tends to be stable with small variations in working voltage. What is more, the olivine-type lithium-containing phosphate material shows a relatively high theoretical capacity, from about 140 mAh/g to about 170 mAh/g, allowing the battery capacity per unit mass to be high. Furthermore, the olivine-type lithium-containing phosphate material is superior in thermal stability to LiCoO₂ and the like.

However, olivine-type lithium-containing phosphate generally has a high electrical resistance. Therefore, when charged/discharged at a large current, a battery employing the olivine-type lithium-containing phosphate suffers an increase in resistance overvoltage and consequently the battery voltage reduces, leading to the problem of poor charge-discharge performance. Moreover, the thermal stability under high temperature conditions is not sufficient.

Conventionally, the use of a composite material of an olivine-type lithium-containing phosphate and a carbon material for the positive electrode active material has been proposed to lower the internal resistance of the battery (see, for example, Japanese Published Unexamined Patent Application Nos. 2002-110161, 2002-110162, 2002-110163, 2002-110164, and 2002-110165.

Nevertheless, even with the use of such a composite material of an olivine-type lithium-containing phosphate and a carbon material as the positive electrode active material, it still has been difficult to sufficiently lower the internal resistance of the battery. When the battery is charged/discharged at a large current, the battery voltage lowers, which means that the charge-discharge performance at large current has not been improved sufficiently. In addition, the thermal stability under high temperature conditions has not been improved sufficiently.

In addition, in order to improve the thermal stability of the positive electrode, it has been proposed to use a composite material composed of a olivine-type lithium-containing phosphate and another lithium-containing metal oxide, such as LiCoO₂ or a lithium-containing metal oxide having a spinel structure (see, for example, Japanese Published Unexamined Patent Application Nos. 2001-307730 and 2002-216755).

Nevertheless, even the use of such composite materials as described above has not sufficiently improved the thermal stability under high temperature conditions. A further problem associated with the use of such composite materials is that the lithium-containing metal oxides other than the olivine-type lithium-containing phosphate also cause charge-discharge reactions, and consequently, variations in the battery voltage at the initial stage or the final stage of discharge tend to be greater than when using only the olivine-type lithium-containing phosphate.

### BRIEF SUMMARY OF THE INVENTION

Accordingly, it is an object of the present invention to solve the foregoing and other problems of a non-aqueous electrolyte secondary battery that uses a positive electrode containing an olivine-type lithium-containing phosphate as a positive electrode active material. More specifically, it is an object of the present invention to provide a non-aqueous electrolyte secondary battery that shows a small variation in working potential so as to perform the discharge operation with a stable voltage and at the same time exhibits good charge-discharge performance at large current and good thermal stability under high temperature conditions.

In order to accomplish the foregoing and other objects, the present invention provide a non-aqueous electrolyte secondary battery comprising: a positive electrode containing a lithium-free metal oxide, and a positive electrode active material composed of an olivine-type lithium-containing phosphate represented by the general formula LiₓMPO₄, where M is at least one element selected from the group consisting of Co, Ni, Mn, and Fe, and 0 <×<1.3; a negative electrode; and a non-aqueous electrolyte.

In the non-aqueous electrolyte secondary battery according to the present invention, a lithium-free metal oxide is added to the positive electrode containing a positive electrode active material composed of an olivine-type lithium-containing phosphate represented by the general formula LiₓMPO₄ (where M is at least one element selected from the group consisting of Co, Ni, Mn, and Fe , and 0 <×<1.3). Therefore, only the olivine-type lithium-containing phosphate is directly responsible for the charge-discharge reactions, and unlike the cases in which another lithium-containing metal oxide is added, the working voltage does not suffer from large variations at the initial stage or the final stage of discharge, allowing the battery to perform stable discharge operations.

### BRIEF DESCRIPTION OF THE DRAWINGS

FIG. 1 is a schematic illustrative drawing of a test cell using a positive electrode fabricated according to Examples 1 to 3 and Comparative Example 1.

### DETAILED DESCRIPTION OF THE INVENTION

A non-aqueous electrolyte secondary battery in accordance with the present invention comprises a positive electrode, a negative electrode, and a non-aqueous electrolyte. The positive electrode contains a positive electrode active material composed of an olivine-type lithium-containing phosphate represented by the general formula LiₓMPO₄, where M is at least one element selected from the group consisting of Co, Ni, Mn, and Fe , and 0 <×<1.3. The positive electrode also contains a lithium-free metal oxide.

In the above-described non-aqueous electrolyte secondary battery, in order to improve the charge-discharge performance at large current and the thermal stability under high temperature conditions, the lithium-free metal oxide added to the positive electrode is preferably a lithium-free metal oxide containing at least one element selected from the group consisting of Ni, Co, and Mn, such as NiO, Co₃O₄, and Mn₂O₃. In order to further improve the thermal stability under high temperature conditions, it is preferable to use a lithium-free metal oxide containing at least one element selected from the group consisting of Co and Mn, such as Co₃O₄ and Mn₂O₃.

In addition, if the amount of the lithium-free metal oxide added to the positive electrode is too small, it will become difficult to sufficiently improve the charge-discharge performance at large current and the thermal stability under high temperature conditions. On the other hand, if the amount thereof is too large, the relative proportion of the positive electrode active material in the positive electrode will be too small and consequently the charge-discharge capacity will be reduced, making it impossible to obtain sufficient battery performance. Accordingly, the amount of the lithium-free metal oxide should be from 1 to 50 weight % with respect to the total amount of the olivine-type lithium-containing phosphate and the lithium-free metal oxide, preferably from 1 to 40 weight %, and more preferably from 1 to 20 weight %.

In the present invention, the olivine-type lithium-containing phosphate that is used for the positive electrode active material and is represented as LiₓMPO₄ should preferably be an olivine-type lithium-containing phosphate containing Fe as the main element M, which means that Fe is contained by 50 mole % or more, from the viewpoints of lowering the cost and improving the thermal stability. In particular, from the viewpoint of improving the charge characteristics at large current, it is more preferable to use LiFePO₄, which has a relatively low charge potential.

When an olivine-type lithium-containing phosphate having an average particle size of 10 μm or less is used as the foregoing olivine-type lithium-containing phosphate, the diffusion path of lithium can be shortened, and thus even better charge-discharge performance at large current can be obtained.

In the non-aqueous electrolyte secondary battery according to the present invention, in preparing the positive electrode, it is possible to use a positive electrode mixture that additionally contains a binder agent and a conductive agent such as a carbon material, in addition to the olivine-type lithium-containing phosphate and the lithium-free metal oxide. When adding a carbon material as a conductive agent to the positive electrode mixture, it is preferable that the amount of the conductive agent composed of a carbon material be within the range of from 3 to 15 weight % in the positive electrode mixture. From the viewpoint of ensuring sufficient energy density, it is preferable that the total amount of the conductive agent composed of a carbon material and the binder agent in the positive electrode be 20 weight % or less. Examples of the carbon material that may be used as the conductive agent include lumped carbon such as acetylene black and fibrous carbon. In particular, when an olivine-type lithium-containing phosphate with a low electron conductivity is used, it is preferable that fibrous carbon such as vapor grown carbon fibers be contained within a range of from 5 to 10 weight %.

The non-aqueous electrolyte used for the non-aqueous electrolyte secondary battery of the present invention is not particularly limited, and it is possible to use any non-aqueous electrolyte that is commonly used. Examples include a non-aqueous electrolyte solution in which a solute is dissolved in a non-aqueous solvent, and a gelled polymer electrolyte in which the just-mentioned non-aqueous electrolyte solution is impregnated in a polymer electrolyte such as polyethylene oxide or polyacrylonitrile.

The non-aqueous solvent is also not limited, and it is possible to use any non-aqueous solvent that has been conventionally used for a non-aqueous electrolyte solution. Examples of the non-aqueous solvent include cyclic carbonates such as ethylene carbonate, propylene carbonate, butylene carbonate, and vinylene carbonate; and chain carbonates such as dimethyl carbonate, methyl ethyl carbonate, and diethyl carbonate. A mixed solvent of a cyclic carbonate and a chain carbonate is particularly preferable.

The solute is also not particularly limited, and it is possible to use any commonly used non-aqueous electrolyte solute. Examples include LiPF₆, LiBF₄, LiCF₃SO_{3,} LiN(CF₃SO₂)_{2,} LiN(C₂F₅SO₂) _{2,} LiN (CF₃SO₂) (C₄F₉SO₂), LiC (CF₃SO₂)_{3,} LiC (C₂F₅SO₂)₃, LiAsF₆, LiClO₄, Li₂B₁₀Cl₁₀, Li₂B₁₂Cl₁₂, and mixtures thereof. In addition to these lithium salts, it is preferable that the non-aqueous electrolyte contain a lithium salt having an oxalato complex as anions. An example of the lithium salt having an oxalato complex as anions is lithium bis(oxalato)borate.

The negative electrode active material used for the negative electrode in the non-aqueous electrolyte secondary battery of the present invention is not particularly limited, but it is preferable to use a carbon material such as graphite and hard carbon as the negative electrode active material.

It is believed that adding such a lithium-free metal oxide as described above to the positive electrode improves the ionic conductivity in the positive electrode and also prevents the positive electrode active material, the olivine-type lithium-containing phosphate, from reacting with the non-aqueous electrolyte solution even under high temperature conditions, thereby improving the charge-discharge performance at large current and the thermal stability under high temperature conditions. The reason why the reaction between the positive electrode active material, i.e., the olivine-type lithium-containing phosphate, and the non-aqueous electrolyte solution is prevented under high temperature conditions is believed to be because the decomposition products of the non-aqueous electrolyte solution are specifically adsorbed onto, or react with, the lithium-free metal oxide.

As a result, the present invention makes available a non-aqueous electrolyte secondary battery that exhibits good charge-discharge performance at large current and good thermal stability under high temperature conditions. Thus, the non-aqueous electrolyte secondary battery according to the present invention may suitably be used in applications that require high-rate discharge characteristics, such as power sources for power tools, hybrid automobiles, and power assisted bicycles.

### EXAMPLES

Hereinbelow, examples of the non-aqueous electrolyte secondary battery according to the present invention will be described in detail along with a comparative example, and it will be demonstrated that the examples of the non-aqueous electrolyte secondary battery provide improved charge-discharge performance at large current and improved thermal stability under high temperature conditions over the comparative example. It should be construed, however, that the non-aqueous electrolyte secondary battery according to the present invention is not limited to the following examples, but various changes and modifications are possible without departing from the scope of the invention.

In each of the following examples and the comparative example, an olivine-type lithium-containing phosphate composed of LiFePO₄ prepared in the following manner was used as the positive electrode active material.

First, starting materials, iron phosphate octahydrate Fe₃(PO₄)_{2.} 8H₂O and lithium phosphate Li₃PO₄, were mixed at a mole ratio of 1:1, and the mixture was put into a 10 cm-diameter stainless steel pot, along with 1 cm-diameter stainless steel balls, and kneaded for 12 hours with a planetary ball mill that was operated under the following conditions: radius of revolution: 30 cm, revolution speed: 150 rpm, and rotation speed: 150 rpm. Thereafter, the resultant mixture was sintered by an electric furnace in a non-oxidizing atmosphere at 600° C. for 10 hours, whereby an olivine-type lithium-containing phosphate composed of LiFePO₄ was obtained.

### Example 1

In Example 1, a positive electrode was prepared in the following manner. The above-described positive electrode active material composed of LiFePO₄ and a lithium-free metal oxide NiO were mixed at a weight ratio of 9:1. The resultant mixture, a conductive agent made of a carbon material, and an N-methyl-2-pyrrolidone solution in which a binder agent made of polyvinylidene fluoride was dissolved, were mixed so that the mixture, the conductive agent, and the binder agent were in a weight ratio of 90:5:5, to thus prepare a positive electrode slurry. Then, the positive electrode mixture slurry was applied onto an aluminum foil serving as a current collector and then dried. Thereafter, the resultant material was pressure-rolled using pressure rollers, and a current collector tab was attached thereto. Thus, a positive electrode was prepared.

### Example 2

In Example 2, a positive electrode was prepared by mixing the positive electrode active material composed of LiFePO₄ with a lithium-free metal oxide at a weight ratio of 9:1, in the same manner as described in Example 1 above, except that Co₃O₄ was used as the lithium-free metal oxide in place of NiO.

### Example 3

In Example 3, a positive electrode was prepared by mixing the positive electrode active material composed of LiFePO₄ with a lithium-free metal oxide at a weight ratio of 9:1, in the same manner as described in Example 1 above, except that Mn₂O₃ was used as the lithium-free metal oxide in place of NiO.

### Comparative Example 1

In Comparative Example 1, a positive electrode was prepared in the same manner as described in Example 1 above, except that no lithium-free metal oxide was mixed with the positive electrode active material composed of LiFePO₄.

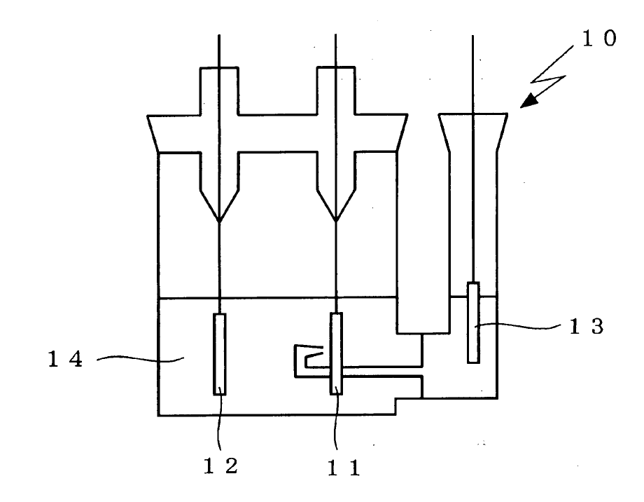

Then, test cells 10 as illustrated in FIG. 1 were prepared using as their working electrodes 11 the positive electrodes prepared in the manners shown in the just-described Examples 1 to 3 and Comparative Example 1.

Each of the test cells 10 also had a non-aqueous electrolyte solution 14, a counter electrode 12, and a reference electrode 13. The non-aqueous electrolyte solution 14 was prepared by dissolving LiPF₆ at a concentration of 1 mol/L into a mixed solvent of 3:7 volume ratio of ethylene carbonate and diethyl carbonate and further dissolving 1 weight % of vinylene carbonate into the solution. Metallic lithium was used for both the counter electrode 12 and the reference electrode 13.

The just-described non-aqueous electrolyte solution 14 was filled into each of the test cells 10, and then, each respective working electrode 11 prepared in the above-described manners, the counter electrode 12, and the reference electrode 13 were immersed in the non-aqueous electrolyte solution 14.

Next, each of the test cells 10 of Examples 1 to 3 and Comparative Example 1 was charged at a constant current of 1 mA at room temperature until the potential of the working electrode 11 versus the potential of the reference electrode 13 became 4.3 V, and was further charged at a constant voltage of 4.3 V until the current reached 0.01 mA, followed by a rest period of 10 minutes. Thereafter, each of the cells was discharged at a constant current of 1 mA until the potential of the working electrode 11 versus the potential of the reference electrode 13 became 2.0 V. This charge-discharge cycle was repeated three times, and thereafter, each of the test cells 10 was charged at a constant current of 1 mA to 50% state of charge (SOC).

Then, each of the test cells 10 was charged at a current rate of 0.5C for 10 seconds, followed by a rest period of 10 minutes, and thereafter discharged at a current rate of 0.5C for 10 seconds, again followed by a rest period of 10 minutes. Next, each of the test cells 10 was charged at a current rate of 1C for 10 seconds, followed by a rest period of 10 minutes, and thereafter discharged at a current rate of 1C for 10 seconds, again followed by a rest period of 10 minutes. Furthermore, each of the test cells 10 was charged at a current rate of 2C for 10 seconds, followed by a rest period of 10 minutes, and thereafter discharged at a current rate of 2C for 10 seconds, again followed by a rest period of 10 minutes. The highest potential reached during the charging at each of the current rates and the lowest potential reached during the discharging at each of the current rates were measured, and the current rates and the measured potentials were plotted to study I-V profiles during charge and during discharge. From the gradients of the graph obtained, respective I-V resistances during charging and during discharging were determined. The results are shown in Table 1 below.

In addition, discharge open circuit potential (discharge OCP) at a current rate of 0 was determined based on the I-V profile during discharge, which was obtained in the above-described manner. Likewise, charge open circuit potential (charge OCP) at a current rate of 0 was determined based on the I-V profile during charge, which was obtained in the above-described manner. Discharge power during discharge at 2.0 V and regenerative power during charge at 4.3 V were determined using the following equations. The results are also shown in Table 1 below.
Discharge power=[(Discharge OCP−2.0)/I-V resistance during discharge]×2.0
Regenerative power=[(4.3−Charge OCP)/I-V resistance during charge]×4.3

TABLE 1

| | Li-free | I-V resistance | | Discharge | Regenerative |
|---|---|---|---|---|---|
| | metal | (Ω) | | power | power |
| | oxide | Discharge | Charge | (mW) | (mW) |
| Ex. 1 | NiO | 7.49 | 7.83 | 380 | 471 |
| Ex. 2 | Co₃O₄ | 8.64 | 9.10 | 331 | 408 |
| Ex. 3 | Mn₂O₃ | 7.93 | 8.19 | 369 | 462 |
| Comp. | Not added | 12.4 | 12.1 | 229 | 303 |
| Ex. 1 | | | | | |

The results demonstrate that the batteries of Examples 1 to 3, which employed the positive electrodes each containing a lithium-free metal oxide such as NiO, Co₃O_{4,} or Mn₂O_{3,} in addition to the positive electrode active material composed of LiFePO₄, exhibited significantly lower I-V resistances during discharge and charge, and significantly higher discharge power and regenerative power than the battery of Comparative Example 1, which used the positive electrode in which no lithium-free metal oxide was added to the positive electrode active material LiFePO₄. This means that the batteries of Examples 1 to 3 achieved a significant improvement in charge-discharge performance at large current over the battery of Comparative Example 1.

In addition, each of the test cells 10 of Examples 1 to 3 and Comparative Example 1, prepared in the foregoing manners, was charged at a constant current of 1 mA at room temperature until the potential of the working electrode 11 versus the potential of the reference electrode 13 became 4.3 V, and was further charged at a constant voltage of 4.3 V until the current reached 0.01 mA, followed by a rest period of 10 minutes. Thereafter, each of the cells was discharged at a constant current of 100 mA until the potential of the working electrode 11 versus the potential of the reference electrode 13 became 2.0 V. The average working potential of each working electrode 11 versus the potential of the reference electrode 13 during discharge was obtained. The results are shown in Table 2 below.

TABLE 2

| | | Average working potential |
|---|---|---|
| | Li-free metal | during discharge at 100 mA |
| | oxide | (V vs. Li⁺/Li) |
| Ex. 1 | NiO | 2.85 |
| Ex. 2 | Co₃O₄ | 2.78 |
| Ex. 3 | Mn₂O₃ | 2.75 |
| Comp. Ex. 1 | Not added | 2.50 |

The results demonstrate that the batteries of Examples 1 to 3, which employed the positive electrodes each containing a lithium-free metal oxide such as NiO, Co₃O₄, or Mn₂O₃ in addition to the positive electrode active material composed of LiFePO₄, achieved significantly higher average working potentials during discharge at 100 mA than the battery of Comparative Example 1, which used the positive electrode in which no lithium-free metal oxide was added to the positive electrode active material LiFePO₄. This is believed to be because the addition of a lithium-free metal oxide, such as NiO, Co₃O₄, or Mn₂O₃, to the positive electrode active material composed of LiFePO₄ improves the ionic conductivity in the positive electrode and reduces the resistance overvoltage.

In addition, each of the test cells 10 of Examples 1 to 3 and Comparative Example 1 was charged at a constant current of 1 mA at room temperature until the potential of the working electrode 11 versus the potential of the reference electrode 13 became 4.3 V, and was further charged at a constant voltage of 4.3 V until the current reached 0.01 mA. Thereafter, each of the test cells 10 was disassembled to take out the positive electrode in a charged state in an argon atmosphere, and 3 mg of the positive electrode mixture layer and 2 mg of the above-described non-aqueous electrolyte solution were placed into a container for the measurement and heated at a temperature elevation rate of 5° C./min. The heat generation starting temperature of each of the samples was measured with a differential scanning calorimeter (DSC). The results are shown in Table 3 below.

TABLE 3

| | | Heat generation starting |
|---|---|---|
| | Li-free metal | temperature |
| | oxide | (° C.) |
| Ex. 1 | NiO | 278 |
| Ex. 2 | Co₃O₄ | 288 |
| Ex. 3 | Mn₂O₃ | 318 |
| Comp. Ex. 1 | Not added | 274 |

The results demonstrate that the positive electrodes of Examples 1 to 3, each of which contains a lithium-free metal oxide such as NiO, Co₃O₄, or Mn₂O₃ in addition to the positive electrode active material composed of LiFePO₄, exhibited higher heat generation starting temperatures than the positive electrode of Comparative Example 1, in which no lithium-free metal oxide was added to the positive electrode active material LiFePO₄. This demonstrates that the positive electrodes of Examples 1 to 3 are capable of suppressing reactions with the non-aqueous electrolyte under high temperature conditions.

When comparing the positive electrodes of Examples 1 to 3 with one another, it was demonstrated that the addition of Co₃O₄ or Mn₂O₃ as the lithium-free metal oxide to the positive electrode active material composed of LiFePO₄ further raises the heat generation start temperature, making it possible to further suppress the reaction with the non-aqueous electrolyte solution under high temperature conditions.

Although the results obtained in the Examples and Comparative Examples were obtained using a test cell in which lithium is used as the counter electrode and the reference electrode, comparable results can be expected in the battery of the present invention using carbon for the negative electrode.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for explanation only, and is not intended to limit the invention as defined by the appended claims and their equivalents.

This application claims priority of Japanese patent application No. 2006-092675 filed Mar. 30, 2006, which is incorporated herein by reference.

What is claimed is:

1. A non-aqueous electrolyte secondary battery comprising:
a positive electrode containing a lithium-free metal oxide, and a positive electrode active material composed of an olivine-type lithium-containing phosphate represented by the general formula LiₓMPO₄, where M is at least one element selected from the group consisting of Co, Ni, Mn, and Fe , and 0<x<1.3;
a negative electrode;
and a non-aqueous electrolyte.

2. The non-aqueous electrolyte secondary battery according to claim 1, wherein the lithium-free metal oxide contains at least one element selected from the group consisting of Ni, Co, and Mn.

3. The non-aqueous electrolyte secondary battery according to claim 2, wherein the lithium-free metal oxide contains at least one element selected from the group consisting of Co and Mn.

4. The non-aqueous electrolyte secondary battery according to claim 1, wherein the element M in the olivine-type lithium-containing phosphate represented by the general formula LiₓMPO₄ contains iron as its main element.

5. The non-aqueous electrolyte secondary battery according to claim 2, wherein the element M in the olivine-type lithium-containing phosphate represented by the general formula LiₓMPO₄ contains iron as its main element.

6. The non-aqueous electrolyte secondary battery according to claim 3, wherein the element M in the olivine-type lithium-containing phosphate represented by the general formula LiₓMPO₄ contains iron as its main element.
